(19) United States
(12) Patent Application Publication
(10) Pub. No.: US 2026/0279777 A1
(43) Pub. Date: Sep. 17, 2026

(54) COMPOSITE CATHODE ACTIVE MATERIAL FOR DRY MANUFACTURING PROCESS FOR SECONDARY BATTERIES AND MANUFACTURING METHOD THEREOF

(71) Applicants: POSTECH RESEARCH AND BUSINESS DEVELOPMENT FOUNDATION, Pohang-si (KR); UNIST(ULSAN NATIONAL INSTITUTE OF SCIENCE AND TECHNOLOGY), Ulsan (KR)

(72) Inventors: Kyu Young PARK, Pohang-si (KR); Kyeong Min JEONG, Cheonan-si (KR); Jong Gyu PARK, Pohang-si (KR); Hye Seong OH, Ulsan (KR)

(21) Appl. No.: 19/447,149

(22) Filed: Jan. 13, 2026

(30) Foreign Application Priority Data
Mar. 13, 2025 (KR) 10-2025-0032984

(51) Int. Cl. H01M 4/36; H01M 4/02; H01M 4/525; H01M 4/583

(52) U.S. Cl. CPC H01M 4/366; H01M 4/525; H01M 4/583; H01M 2004/021; H01M 2004/028

(57) ABSTRACT

A purpose of the present invention is to provide a composite cathode active material for secondary batteries and its manufacturing method, which are for manufacturing a dry electrode for secondary batteries in a process-efficient manner. To this end, a method for manufacturing the composite cathode active material according to the present invention may include mixing carbon nanotubes and a cellulose-based organic matter with a first solvent to prepare a first solution, irradiating the first solution with ultrasonic waves to disperse the carbon nanotubes and the cellulose-based organic matter, introducing a second solvent to the first solution, the second solvent not being miscible with the first solvent and having a different boiling point therefrom, and mixing the second solvent therewith, to prepare a second solution in a pickering emulsion state, introducing a cathode active material to, and mixing the same with the second solution to prepare a first slurry, removing an internal solvent of droplets forming the pickering emulsion from the first slurry to prepare a second slurry, separating a solid-phase material and a liquid-phase material from the second slurry, and heat-treating the separated solid-phase material.

### BACKGROUND OF THE INVENTION

### 1. Field of the Invention

The present invention relates to a method for manufacturing a secondary battery cathode active material having a carbon layer including carbon nanotubes on a surface thereof, and more particularly, to a secondary battery cathode active material for a dry electrode, which has an increased surface roughness to be suitable for a dry electrode process, and a method for manufacturing the same.

### 2. Description of the Related Art

A dry electrode manufacturing process basic technology for developing an all-solid (four electrode elements (positive/negative electrodes, an electrolyte, and a current collector are all in a solid-state) battery, which is a next-generation secondary battery system. At the same time, this process is technology that overcomes limitations of a typical wet (a method of dispersing an electrode composition in a solvent and then casting the prepared slurry onto a current collector) process. Particularly, the dry electrode manufacturing technology has gained attention due to its potential for reducing carbon emissions during an electrode manufacturing process and for implementing thick-film electrodes.

The following methods are mainly proposed for dry electrode manufacturing.

Hot-pressing method: Applies high temperature/high pressure to induce melting of a polymer binder material, which performs a binding role in an electrode.

Polymer fibrillation method: Applies an external force (mainly, shear force) to induce deformation of a polymer microstructure, and formed fine fibers having a nanometer-scale diameter perform a binding role by intertwining with each other and enclosing an electrode composition.

Spraying method: Disperses an electrode component in a solvent (generally N-Methyl-2-pyrrolidone), and then applies a high level of pressure to spray the same through a spray, thereby molding an electrode. Since a polymer binder is dissolved in the solvent together with the electrode component, the solvent dries during the spraying through spraying, and performs a binding role in the electrode.

Among the proposed methods, the polymer fibrillation method has attracted attention as next-generation dry electrode manufacturing technology, and this is because its electrode manufacturing process is relatively simple and a current wet process-based electrode manufacturing facility may be utilized as it is.

A dry electrode manufacturing process through fibrillation is generally batch-type, which is composed of processes of mixing electrode components in a dry manner, fiberizing a polymer binder in the mixed components, pulverizing fiberized electrode paste, molding a free-standing electrode film through milling of the pulverized powder, and roll-pressing and attaching the free-standing electrode film to an upper portion or a lower portion of a current collector (metal thin film).

A fibrillation process has a significant impact on mechanical and electrochemical properties of a dry electrode, and since a high degree of fibrillation is required, techniques for improving the degree of fibrillation have been proposed, such as increasing the mixing time of electrode components or performing the fibrillation process in a temperature-rising environment (~80° C.).

The essence of improving the degree of polymer fibrillation lies in transmitting uniform shear force to polymer binder particles dispersed in an electrode. Previously proposed solution strategies have the problem of requiring a significant amount of time and energy for the process. In addition, as a polymer fibrillation process is performed in a temperature-rising environment, energy consumption between fibrillation unit processes increases, and there is no significant decrease in the total process progress time, regardless of the degree of fibrillation of a polymer.

### SUMMARY OF THE INVENTION

A purpose of the present invention is to provide a composite cathode active material for secondary batteries and a manufacturing method thereof, which are for manufacturing a dry electrode for secondary batteries in a process-efficient manner.

In addition, another purpose of the present invention is to provide a dry electrode for secondary batteries having improved electrochemical properties.

In order to achieve the above-described purposes, a composite cathode active material for secondary batteries according to the present invention may be characterized by including a core, which is a lithium-based active material, and a carbon layer formed on the surface of the core, wherein the carbon layer has carbon nanotubes dispersed and disposed on an amorphous carbonized layer, and results of surface roughness analysis performed five times or more by using Conductive-Atomic Force Microscopy (C-AFM) show that an average Rₐ is 2.5 nm or greater, an average R_{q} is 3.0 nm or greater, and an average R_{z} is 11.0 nm or greater.

In addition, a composite cathode active material for secondary batteries according to an embodiment of the present invention may have the average Rₐ of 5.0 nm or greater, the average R_{q} of 6.0 nm or greater, and the average R_{z} of 22.0 nm or greater.

In addition, in a composite cathode active material for secondary batteries according to an embodiment of the present invention, the carbon nanotubes may have an aspect ratio in the range of 500 to 40,000.

In addition, in a composite cathode active material for secondary batteries according to an embodiment of the present invention, the core, which is a lithium-based active material, may be a layered-structured oxide having a nickel content of 60 mol % or greater.

In addition, a composite cathode active material for secondary batteries according to an embodiment of the present invention may have a specific surface area in the range of 2 m²/g to 5 m²/g based on BET.

In addition, in a composite cathode active material for secondary batteries according to an embodiment of the present invention, the carbon layer may be manufactured by using a pickering emulsion process.

Meanwhile, a method for manufacturing the composite cathode active material for secondary batteries according to the present invention may include mixing carbon nanotubes and a cellulose-based organic matter with a first solvent to prepare a first solution, irradiating the first solution with ultrasonic waves to disperse the carbon nanotubes and the cellulose-based organic matter, introducing a second solvent to the dispersion-treated first solution, the second solvent not being miscible with the first solvent and having a different boiling point therefrom, and mixing the second solvent therewith, to prepare a second solution in a pickering emulsion state, introducing a cathode active material to, and mixing the same with the second solution to prepare a first slurry, removing an internal solvent of droplets forming the pickering emulsion from the first slurry to prepare a second slurry, separating a solid-phase material and a liquid-phase material from the second slurry, and heat-treating the separated solid-phase material.

In addition, according to an embodiment of the method for manufacturing the cathode active material for secondary batteries according to the present invention, the cellulose-based organic matter may be selected from the group consisting of ethyl cellulose, cellulose acetate, carboxymethyl cellulose, hydroxypropyl cellulose, methyl cellulose, nitrocellulose, and a combination thereof.

In addition, according to an embodiment of the method for manufacturing the cathode active material for secondary batteries according to the present invention, the first solvent or the second solvent may be selected from the group consisting of polar substances such as water, methanol, ethanol, acetic acid, acetone, dimethyl sulfoxide, acetonitrile, and a combination thereof, and non-polar substances such as heptane, hexane, benzene, toluene, chloroform, and a combination thereof.

In addition, according to an embodiment of the method for manufacturing the cathode active material for secondary batteries according to the present invention, the weight ratio of the cellulose-based organic matter to the carbon nanotubes may be in the range of 1 to 5.

In addition, according to an embodiment of the method for manufacturing the cathode active material for secondary batteries according to the present invention, the preparation of the pickering emulsion may include introducing the second solvent to the first solution and irradiating ultrasonic waves.

In addition, according to an embodiment of the method for manufacturing the cathode active material for secondary batteries according to the present invention, the heat-treatment may be performed in the range of 150° C. to 800° C., and may be a step of carbonizing the cellulose-based organic matter.

Meanwhile, according to the present invention, a dry electrode for secondary batteries including the above-described cathode active material for secondary batteries may be provided.

In addition, according to the present invention, a secondary battery including the above-described dry electrode for secondary batteries may be provided.

### Advantageous Effects

Through a method for manufacturing a composite cathode active material for secondary batteries according to the present invention, a composite cathode active material with carbon nanotubes uniformly dispersed on the surface thereof is manufactured, so that it is possible to provide a dry electrode having reduced process time in a dry manufacturing process and having improved electrical properties and mechanical properties.

### BRIEF DESCRIPTION OF THE DRAWINGS

FIGS. 1(a) and 1(b) show scanning electron microscope images before and after coating treatment of a composite cathode active material according to an embodiment of the present invention.

FIG. 2 shows results of measuring a BET specific surface area before and after coating treatment of a composite cathode active material according to an embodiment of the present invention.

FIG. 3 shows results of measuring a torque of process equipment over time, measured during a dry manufacturing process using a composite cathode active material according to each of an embodiment and comparative embodiments of the present invention.

FIG. 4 shows results of measuring maximum torque of process equipment and the time required to reach the maximum torque, measured during a dry manufacturing process using a composite cathode active material according to an embodiment and comparative embodiments of the present invention.

FIG. 5 shows results of evaluating mechanical properties of a dry electrode including a composite cathode active material according to each of an embodiment and comparative embodiments of the present invention.

FIG. 6 shows results of evaluating electrical properties of a dry electrode including a composite cathode active material according to each of an embodiment and comparative embodiments of the present invention.

### DETAILED DESCRIPTION OF THE EXEMPLARY EMBODIMENTS

Hereinafter, embodiments of the present application will be described in detail with reference to the accompanying drawings so that those skilled in the art to which the present application pertains may easily practice the embodiments. However, the present application may be embodied in many different forms and should not be construed as limited to the embodiments set forth herein.

Throughout the present specification, when a part is referred to as “including” another component, it means the part may further include other components, rather than excluding other components, unless specifically stated otherwise.

The terms “about,” “substantially,” and the like used herein are used in a sense that is close to a numerical value presented with a manufacturing and material tolerance specific to a stated meaning, and is used to prevent an unscrupulous person from abusing a disclosure in which an exact or absolute value is stated in order to facilitate the understanding of the present application. In addition, the term “a step ~ing,” or “a step of ~,” as used throughout the present specification, does not mean “a step for ~.”

Throughout the present specification, the term “a combination thereof” included in an expression of the Markush form means one or more mixtures or combinations selected from the group consisting of components described in the expression of the Markush form, and means to include one or more selected from the group consisting of the components.

Throughout the present specification, the description of “A and/or B” means “A or B, or A and B.”

A composite cathode active material according to the present invention is characterized in that a carbon layer is formed on the surface of a lithium-based active material for lithium secondary batteries, wherein the carbon layer has carbon nanotubes dispersed and disposed on an amorphous carbonized layer. As a result, the surface roughness may be increased, and at the same time, the conductivity of the active material in an electrode may be increased.

In general, improving the degree of fibrillation by increasing the mixing time of electrode components is to uniformly and effectively transmit shear force, which is transmitted to polymer particles during a unit process of performing the fibrillation of a polymer. Accordingly, since the increase in the degree of polymer fibrillation is determined by how efficiently the shear force is applied, it is possible to decrease process time by improving the area of a friction counterface that mediates the shear force.

In the polymer fibrillation unit process, the friction counterface that transmits the shear force to the polymer particles may be divided into an electrode composition (solid particles) and a wall surface of process equipment such as a kneader or mortar. In the case of improving the surface roughness of the wall surface of the process equipment to increase the area of the friction counterface, there is a possibility of contamination during repetitive unit processes, and if excessive force is transmitted, the lifespan performance of an electrode may be significantly deteriorated due to fracture and rupture of an active material.

Accordingly, in the present invention, the surface roughness of an active material, which occupies a large fraction in a dry-thick film electrode, is modified among electrode compositions. Modifying the surface roughness of an active material by creating a concave pattern on its surface involves creating a type of cracks on the surface of an individual active material, and it is preferable to form convex surface roughness, as the formed cracks may serve as starting points for deterioration of the active material which progresses during an electrochemical reaction.

Coating heterogeneous materials on the surface of an active material for surface modification to a convex shape is already well known in the field of secondary batteries, and is an effective methodology. Particularly, since incorporating an external material into an electrode is disadvantageous in terms of energy density, it is preferable to use a material which does not inhibit energy density, and which may be coated on the surface of an active material. In addition, effectively transmitting shear force means transmitting a force required for the microstructure deformation of a polymer binder material. Since this microstructure is a structure having a unit in several tens of nanometers to several micrometers, it is necessary to select a coating material corresponding to the scale.

One of materials recently attracting attention in secondary battery development is carbon nanotubes (CNTs). Compared to typical materials such as carbon black, CNTs have a characteristic of having excellent electron conductivity due to their high aspect ratio. Moreover, the diameter of carbon nanotubes varies depending on the product grade of single-walled and multi-walled types.

Accordingly, the material selected for active material surface roughness modification in the present invention is carbon nanotubes, and particularly, multi-walled carbon nanotubes are preferred. In addition, in order to uniformly disperse these carbon nanotubes and bind the carbon nanotubes to the surface of an active material, an amorphous carbon layer is formed and the carbon nanotubes are dispersed and disposed in the layer.

A composite cathode active material formed through the above-described disposition of carbon nanotubes has increased surface roughness, and quantitatively, this can be expressed as an average Rₐ of 2.5 nm or greater, an average R_{q} of 3.0 nm or greater, and an average R_{z} of 11.0 nm or greater, as results of surface roughness analysis performed five times or more by using Conductive-Atomic Force Microscopy (C-AFM) show.

The higher the roughness of a surface of an active material, the higher the process efficiency for a dry electrode, and to this end, in the present invention, uniform carbon nanotubes are disposed on the surface, thereby effectively increasing surface roughness in a micro-region.

Accordingly, the surface roughness of the composite cathode active material according to the present invention is analyzed five times or more by using C-AFM, and according to the analysis, an average Rₐ may be 2.5 nm or greater, an average R_{q} may be 3.0 nm or greater, and an average R_{z} may be 11.0 nm or greater.

Among parameters which define surface roughness, Rₐ represents an average value of absolute values of heights measured based on a centerline of a surface. This is the most common method for measuring surface roughness, and the higher the value, the rougher the surface. R_{q}, also known as root mean square roughness, is the square root of the mean of the squared vertical deviations from the mean line. R_{q} is more sensitive to peaks and valleys than Rₐ, with higher values indicating greater surface irregularity. The higher the value, the more irregular the surface. In addition, R_{z} represents the average of the sum of the maximum peak height and the maximum valley depth measured across multiple sampled sections. This value is sensitive to peak-valley changes on the surface. Although there are many numerical definitions for expressing surface roughness, it has been determined that the above three roughness 1 evaluations are most appropriate for defining the roughness of a surface of an active material.

Typically, in the case of an active material having a carbon layer formed on the surface thereof, convexity is sometimes used to define roughness, but this convexity is a value which can be obtained from an image of the entire active material, representing the ratio of perimeter values connecting convex points on a particle cross-section. This is an indicator for evaluating how spherical the entire active material is, and is a different concept from the actual height of surface roughness itself. Therefore, it is insufficient as an indicator for accurately evaluating surface roughness capable of increasing efficiency in an actual dry electrode process.

The composite cathode active material according to the present invention is defined through surface roughness, and the surface roughness may be measured though C-AFM, and the surface roughness according thereto may have an average Rₐ of 2.5 nm or greater, preferably 3.5 nm or greater, and more preferably 5.0 nm or greater, an average R_{q} of 3.0 nm or greater, preferably 5.0 nm or greater, and more preferably 6.0 nm or greater, and an average R_{z} of 11.0 nm or greater, preferably 15.0 nm or greater, and more preferably 22.0 nm or greater.

A lithium-based active material before coating, which serves as a base material in the composite cathode active material according to the present invention, may be various oxides, sulfides, or phosphates, and particularly, in an embodiment of the present invention, the lithium-based active material may be a layered-structured oxide having a nickel content of 60% or greater. A cathode active material containing nickel and a small amount of cobalt, and thus, is referred to as a ternary oxide, has the advantage of high capacity, but ensuring the stability is also an important issue, and therefore, establishing a dry electrode process using this active material will become essential in the future.

In addition, the composite cathode active material according to an embodiment of the present invention may have a specific surface area in the range of 2 m²/g to 5 m²/g based on BET. In order to impart appropriate shear force during the process, the specific surface area of the cathode active material surface needs to be above a certain level, but if the specific surface area is too high, a mixing process becomes difficult. Therefore, it is necessary to appropriately control the specific surface area, preferably in the range of 2 m²/g to 5 m²/g, and more preferably in the range of 3 m²/g to 4 m²/g.

In the composite cathode active material according to the present invention, the formation of the coating layer may be achieved using a chemical pickering emulsion process. A typical method for coating the surface of an active material is performed through a dry mechano-fusion process, but this dry coating method may induce deterioration of the surface of an active material particle due to a strong external force, and the surface roughness may be increased not by an intended material such as CNTs, but due to damage to a core particle. Such damage ultimately leads to deterioration in properties of the active material. In contrast, the composite cathode active material according to the present invention may have a conformal coating layer formed without the damage to a core by using a stable chemical pickering emulsion solution.

As such, a method for manufacturing the composite cathode active material according to the present invention may include mixing carbon nanotubes and a cellulose-based organic matter with a first solvent to prepare a first solution, irradiating the first solution with ultrasonic waves to disperse the carbon nanotubes and the cellulose-based organic matter, introducing a second solvent to the dispersed first solution, the second solvent not being miscible with the first solvent and having a different boiling point therefrom, and mixing the second solvent therewith, to prepare a second solution in a pickering emulsion state, introducing a cathode active material to, and mixing the same with the second solution to prepare a first slurry, removing an internal solvent of droplets forming the pickering emulsion from the first slurry to prepare a second slurry, separating a solid-phase material and a liquid-phase material from the second slurry, and heat-treating the separated solid-phase material.

As described above, the composite cathode active material according to the present invention is characterized by having a carbon layer on the surface thereof, the carbon layer including an amorphous carbonized layer on which carbon nanotubes are dispersed and disposed. As a method for manufacturing the composite cathode active material, the present invention utilizes a pickering emulsion system in which a mixture of a cellulose-based organic matter and carbon nanotubes are mixed with two or more solvents that do not mix with each other and have different boiling points.

In general, carbon nanotubes tend to easily aggregate due to strong van der Waals forces. To address this issue, the present invention uses a cellulose-based organic matter to easily separate carbon nanotube bundles in a solvent, and to maintain their dispersed state well.

To this end, carbon nanotubes and a cellulose-based organic matter are first introduced to a first solvent and mixed, followed by ultrasonic irradiation to disperse the carbon nanotubes and the cellulose-based organic matter. Thereafter, a second solvent not miscible with the first solvent and having a different boiling point is introduced thereto and mixed to prepare a second solution in a pickering emulsion state.

Here, the cellulose-based organic matter may be selected from the group consisting of ethyl cellulose, cellulose acetate, carboxymethyl cellulose, hydroxypropyl cellulose, methyl nitrocellulose, and cellulose, a combination thereof. This cellulose-based organic matter is advantageous in facilitating dispersion of nanotubes in a solution and subsequently forming an amorphous carbonized layer on the surface of the cathode active material through heat treatment.

The carbon nanotubes may have an average aspect ratio of 100 to 50,000, for example, 500 to 40,000, 5,000 to 30,000, or 10,000 to 25,000. The average aspect ratio of carbon nanotubes refers to the ratio (average length/average diameter ratio) of an average length to an average diameter.

The average aspect ratio of carbon nanotubes may be calculated by measuring an average diameter and an average length and dividing the average length by the average diameter. Here, the average diameter and the average length may be average values of values of lengths as measured by observing 10 or more carbon nanotubes by using a scanning electron microscope (SEM). If the aspect ratio of the carbon nanotubes satisfies the aforementioned range, it is possible to increase the ratio of a cathode electrode active material covered per carbon nanotubes of the same weight, thereby providing an effect of coating the overall surface of the cathode active material.

Meanwhile, the ratio of the carbon nanotubes to the cellulose-based organic matter may be in a weight ratio of 1:1 to 1:5. The cellulose-based organic matter should be mixed with the carbon nanotubes at an appropriate level in terms of weight ratio to sufficiently disperse the carbon nanotubes while increasing binding force at the surface.

After mixing the carbon nanotubes and the cellulose-based organic matter in the first solvent, the carbon nanotubes and a cellulose additive are dispersed using a sonication method. In this case, as hydrogen bonding progresses, the cellulose-based organic matter suppresses strong van der Waals forces between the carbon nanotubes, thereby preventing aggregation.

A non-uniformly dispersed mixed solution of the carbon nanotubes and the cellulose-based organic material creates an aggregation region of the carbon nanotubes when coating the surface of an active material, and accelerates deterioration of the active material by causing current density concentration in actual electrochemical driving. Accordingly, it is essential to form a uniformly dispersed mixed solution.

A second solvent is introduced to the first solvent, which has been mixed and dispersed, to form a pickering emulsion. The second solvent used in this case is not miscible with the first solvent, and has a different boiling point therefrom, so that it is possible to subsequently remove the second solvent through fractional distillation.

The first solvent or the second solvent may be selected from the group consisting of polar substances such as water, methanol, ethanol, acetic acid, acetone, dimethyl sulfoxide, acetonitrile, and a combination thereof, and non-polar substances such as heptane, hexane, benzene, toluene, chloroform, and a combination thereof. If the first solvent is a polar solvent, the second solvent is selected from non-polar solvents, and if the first solvent is a non-polar solvent, the second solvent is selected from polar solvents, to prevent the first solvent and the second solvent from being mixed with each other.

A physical external force is applied to a mixed solution, to which the second solvent has been introduced, to form a pickering emulsion. In this case, the carbon nanotubes and the cellulose-based organic matter dispersed in the mixed solution may serve as stabilizers at an interface between the first solvent and the second solvent. More specifically, the cellulose-based organic matter is positioned as a stabilizer at a solvent interface, and the carbon nanotubes forming hydrogen bonds with the stabilizer are in the form of being physically adsorbed. In this case, positions of the first and second solvents inside/outside the pickering emulsion are determined by the amount of the solvents introduced. That is, a solvent in a smaller amount serves as an internal solvent of pickering emulsion droplets, and a solvent in a larger amount serves as an external solvent of the droplets. The degree of coating uniformity varies depending on the size of formed pickering emulsion droplets, the type of a solvent used, and dispersion properties of a dispersant.

The formation of the pickering emulsion may be achieved by applying a physical external force. For example, droplets of the pickering emulsion are formed through vortexing and sonication.

A cathode active material is introduced to a mixed solution in which the pickering emulsion has been formed. In this case, it is necessary to control the size of the droplets of the pickering emulsion according to a particle diameter of the introduced active material. If the size of a droplet is too large, a large amount of carbon nanotubes is present at a droplet interface (the interface between the first and second solvents), with respect to the surface area of the introduced active material in the emulsion, resulting in non-uniform coating. If the size of a droplet is too small, the active material cannot be introduced into the corresponding droplet, preventing a desired coating effect from being achieved. The size of a droplet is determined by the ratio of the first and second solvents introduced. The degree of coating uniformity, which is determined by the size of a droplet, ultimately plays an important role in electrochemical performance after manufacturing a coated active material though the implementation of the invention. Particularly, it has a significant impact on the current density at different positions on the surface of the active material during charging/discharging, so that it is important to control the size of a droplet.

The active material introduced to the mixed solution may penetrate into the pickering emulsion droplet as the physical external force is applied. For example, the active material is inserted into the pickering emulsion droplet through a method of stirring or vertexing.

The solvent inside the pickering emulsion droplet is removed through fractional distillation from a first slurry thus prepared. As described above, the first solvent and the second solvent have different boiling points from each other, and thus, may be removed under appropriate temperature and pressure conditions.

A second slurry, from which an internal solvent has been removed through fractional distillation, is present in a form in which the active material having the carbon nanotubes and the cellulose-based organic matter coated on the surface thereof is dispersed in an external solvent of the pickering emulsion droplets.

After the fractional distillation (after the internal solvent of the pickering emulsion droplets has been removed), the solvent inside the second slurry and the coated-form active material may be separated through a method of vacuum filtration or centrifugation.

Subsequently, the active material is heat-treated in a specific gas atmosphere in the range of 150° C. to 800° C. Through the heat-treatment, the cellulose-based organic matter is carbonized, which is present on the surface of the active material as an amorphous carbonized layer. The amorphous carbonized layer, in the form of a carbide, may strongly adhere to the surface of the active material, and may mediate adhesion between the active material and the carbon nanotubes, thereby achieving robust coating. As a result, it is possible to finally manufacture a composite cathode active material in which a carbon layer including an amorphous carbonized layer and carbon nanotubes dispersed and disposed on the amorphous carbonized layer is firmly formed on the surface of the cathode active material.

### EXAMPLE

Ethyl cellulose was used as a cellulose-based organic matter, and multi-walled carbon nanotubes were used as carbon nanotubes. The corresponding multi-walled carbon nanotubes were carbon nanotubes having an average diameter of 6 nanometers, and having 3 to 5 multi-walls.

The multi-walled carbon nanotubes and the ethyl cellulose were mixed in a weight ratio of 1:5 with acetonitrile, which was a first solvent. The mixed solution was subjected to dispersion for an appropriate duration through sonication. In this case, the ethyl cellulose serves as a dispersant, and prevents aggregation of the multi-walled carbon nanotubes in the mixed solution.

As a second solvent, hexane was added to the formed carbon nanotube dispersion solution. A cathode active material used in the present invention was a single-crystal material having an average diameter (D₅₀) of 4 nm. The size of droplets of pickering emulsion to ensure uniform coating on the surface of the corresponding material was determined by the ratio of the first solvent and the second solvent. In the present invention, the first solvent and the second solvent were mixed in a volume ratio of 8:1.

An external force was applied to the mixed solution though vortexing. The two types of solvents, which were not miscible with each other, formed an emulsion due to a strong physical force. Subsequently, a cathode active material was introduced to a mixed solution in which the emulsion was formed. In this case, the content of the cathode active material is determined according to a target coating amount of a cathode material surface conductive material (carbon nanotubes). In the present invention, 0.5 wt % of carbon nanotube coating on the surface of the active material was targeted, and a cathode material measured accordingly was introduced.

An additional physical force was applied to ensure that the introduced cathode active material was sufficiently inserted into the emulsion formed in the mixture solution. Methods such as vortexing and sonication described above were applied.

If the cathode active material is sufficiently inserted into the emulsion, a relatively heavy active material sinks to the bottom of the solution along with the emulsion.

A rotary evaporator (rota vapor) was used for the fraction distillation. The solution was subjected to an appropriate temperature (near the boiling point of the second solvent, hexane (~68° C.)) in the rotary evaporator. After the second solvent was separated, an obtained solution was separated from a solid phase. In this case, as the second solvent is separated, the obtained solution is in a state in which the carbon nanotubes and the dispersant, which were dispersed on the emulsion surface, are uniformly attached to the surface of the cathode active material, and the corresponding cathode material is mixed in the first solvent.

Filtration was performed to separate solid phases of the first solvent, the cathode active material, the carbon nanotubes, and the dispersant. In order to remove any remaining solvent from a material obtained after removing the first solvent, removing of the remaining solvent was performed in a vacuum oven at an appropriate temperature.

After removing the remaining solvent, heat near 240° C. was applied in an inert atmosphere to induce carbonization of ethyl cellulose on the surface of the cathode active material, thereby achieving strong adhesion of multi-walled carbon nanotubes physically attached to the surface.

### COMPARATIVE EXAMPLES

Components required for a dry electrode manufacturing process are a cathode active material, a binder (PTFE), and a carbon conductive component. In order to verify an effect of active material surface coating, the composition ratio of the same cathode active material and electrode components was fixed, and the type of carbon conductive component was changed.

Comparative Example 1 represents a dry electrode manufactured through a typical dry electrode manufacturing process. In Comparative Example 1, super P was applied as a conductive material, and the composition of a cathode active material and PTFE in an electrode was the same as that in Example.

In Comparative Example 2, multi-walled carbon nanotubes were included as a carbon conductive component instead of being used for coating, and mixed to manufacture a dry electrode.

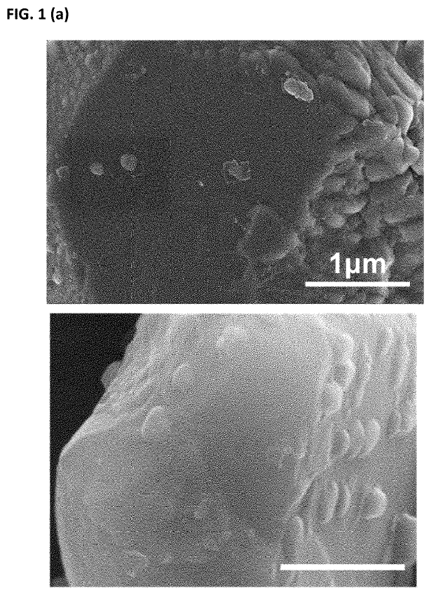

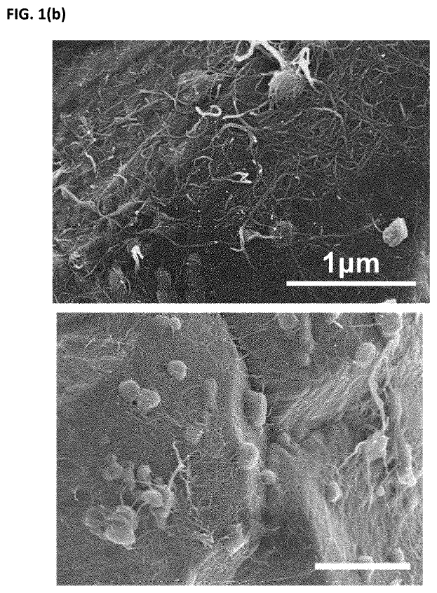

FIG. 1 shows scanning electron microscope images of the surface of a cathode active material before (FIG. 1(a)) and after (FIG. 1(b)) surface coating treatment. After the coating treatment, finely dispersed carbon nanotubes were observed.

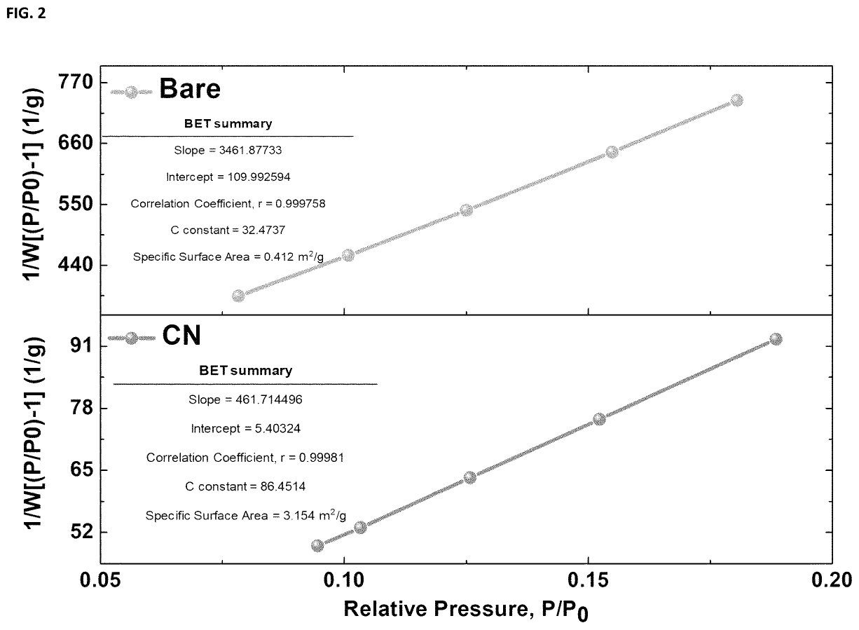

FIG. 2 shows BET specific surface area measurement graphs before and after the coating treatment. The specific surface area of the active material was 0.412 m²/g before the coating treatment and 3.154 m²/g after the coating treatment, indicating a significant increase in the specific surface area after the coating treatment.

Table 1 shows the surface roughness before and after the surface coating treatment. This is the result of measuring the surface roughness by using C-AFM on an active material surface having an area of 1×1 μm².

TABLE 1

| | | Rₐ | R_{q} | R_{z} |
|---|---|---|---|---|
| | | [nm] | [nm] | [nm] |
| After | Line_1 | 3.878 | 4.516 | 17.934 |
| coating | Line_2 | 5.253 | 6.138 | 22.895 |
| | Line_3 | 3.688 | 4.613 | 19.017 |
| | Line_4 | 6.665 | 7.998 | 29.484 |
| | Line_5 | 2.455 | 2.95 | 11.117 |
| | Line_6 | 6.238 | 7.388 | 25.103 |
| | Line_7 | 9.431 | 10.886 | 38.439 |
| Before | Line_1 | 1.343 | 1.843 | 6.390 |
| coating | Line_2 | 2.450 | 2.785 | 9.172 |
| | Line_3 | 0.739 | 0.596 | 3.114 |
| Average | After | 5.372 | 6.348 | 23.427 |
| | coating | | | |
| | Before | 1.463 | 1.789 | 6.225 |
| | coating | | | |
| Standard | After | 2.154 | 2.456 | 8.161 |
| deviation | coating | | | |
| | Before | 0.761 | 0.836 | 2.475 |
| | coating | | | |

Before the coating, average values were Rₐ of 1.46 nm, R_{q} of 1.79 nm, and R_{z} of 6.23 nm, but after the coating, the average values were increased significantly to Rₐ of 5.37 nm, R_{q} of 6.35 nm, and R_{z} of 23.43 nm. In addition, standard deviations were also increased to 2.12, 2.46, and 8.16, respectively, indicating an increase in roughness non-uniformity of the surface. The increase in the roughness may play an important factor in improving process efficiency in a dry process.

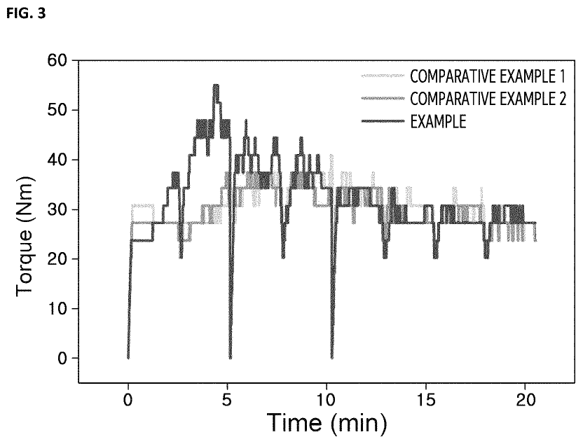

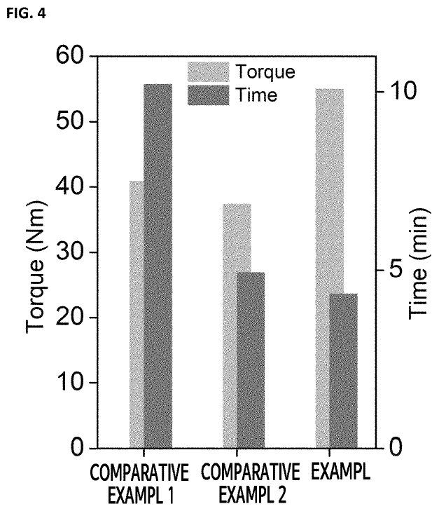

FIG. 3 shows a torque value that resists the rotation of a screw inside a kneader arrangement during a fibrillation process of a dry electrode manufacturing process, and FIG. 4 shows a maximum torque value and the time required to achieve the maximum torque value for each experimental example.

FIGS. 3 and 4 indicate that the maximum torque value, which represents the maximum resistance applied to the screw of the kneader, is the highest in Example. Factors that may apply resistance to the rotation of the screw of the kneader may include an increase in the density of electrode components due to the fibrillation of a polymer binder and a lattice deformation process of polymer particles.

Accordingly, it can be interpreted that the maximum torque value is proportional to the degree of fibrillation. In addition, it can be seen that the time required to achieve the maximum torque value is shortest in Example, which indicates that it is possible to shorten fibrillation process time.

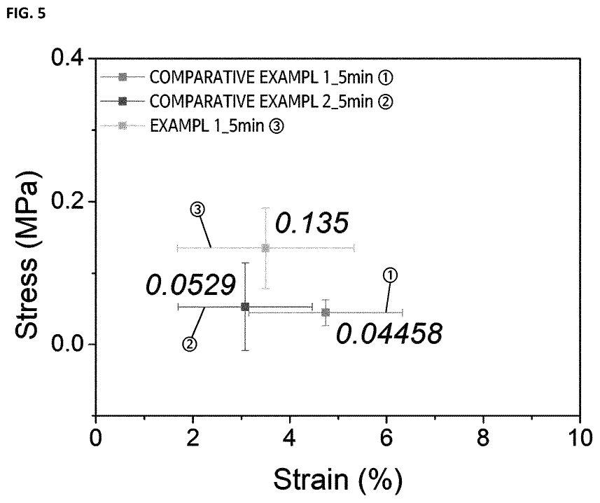

FIG. 5 shows results of measuring the tensile strength of electrodes manufactured according to Example and Comparative Examples. From the result of performing a fibrillation process for 5 minutes, it was observed that the electrode of Example exhibited strength at least twice greater than that of the electrodes according to Comparative Examples.

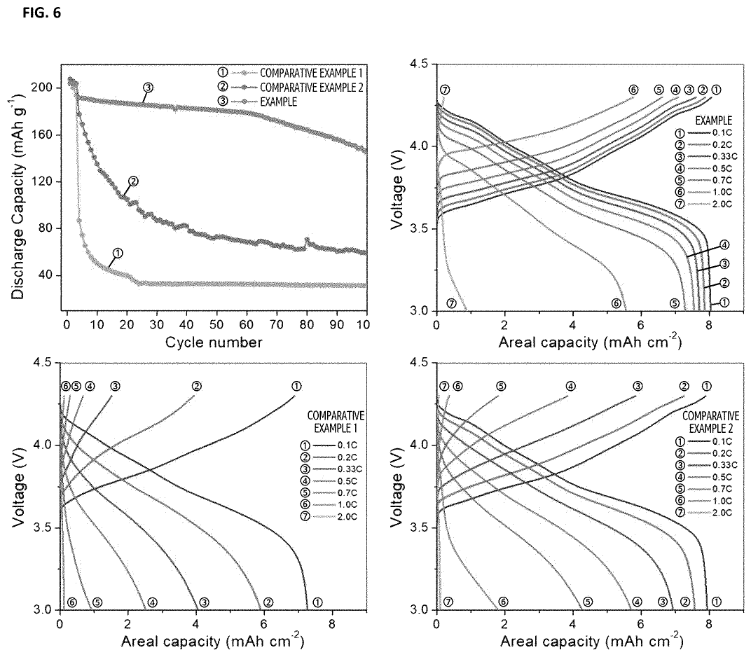

Meanwhile, FIG. 6 shows results of evaluating electrochemical properties of the electrodes according to Example and Comparative Examples. From the results of evaluating lifespan and charge/discharge properties, it was observed that the electrode according to Example exhibited significantly excellent lifespan and charge/discharge properties.

This is considered to be due to an improvement in the degree of polymer fibrillation, which improves electrolyte impregnation in a thick-film electrode, and due to an improvement in the diffusivity of lithium ions in an electrochemical reaction, which improves output performance. In addition, it is determined that the excellent lifespan performance is considered to be due to the coating of multi-walled carbon nanotubes for modifying the surface roughness of an active material and excellent mechanical properties of an electrode based on the improved degree of fibrillation. The significant improvement in the lifespan and output properties of Example as described above is evaluated to be due to the improvement in the degree of polymer binder fibrillation in the dry thick-film electrode according to the modification of the surface roughness of the active material, along with the coating of multi-walled carbon nanotubes on the surface of the active material, which is a strategy for implementing surface roughness modification.

Therefore, a dry electrode which can be provided through the composite cathode active material according to the present invention may ultimately improve the performance of a secondary battery manufactured therefrom.

In addition, the composite cathode active material provided by the present invention may reduce the time consumed for a polymer binder fibrillation process during a dry electrode manufacturing process, and at this same time, may effectively improve the degree of fibrillation. This is referred to as fibrillation acceleration, which implemented a decrease of 50% or more in unit process time compared to previously proposed research documents.

What is claimed is:

1. A composite cathode active material for a secondary battery, the composite cathode active material comprising a core, which is a lithium-based active material, and a carbon layer formed on the surface of the core,
wherein the carbon layer has carbon nanotubes dispersed and disposed on an amorphous carbonized layer, and results of surface roughness analysis performed five times or more by using Conductive-Atomic Force Microscopy (C-AFM) show that an average Rₐ is 2.5 nm or greater, an average R_{q} is 3.0 nm or greater, and an average R_{z} is 11.0 nm or greater.

2. The composite cathode active material of claim 1, wherein the average Rₐ is 5.0 nm or greater, the average R_{q} is 6.0 nm or greater, and the average R_{z} is 22.0 nm or greater.

3. The composite cathode active material of claim 1, wherein the carbon nanotubes have an aspect ratio in the range of 500 to 40,000.

4. The composite cathode active material of claim 1, wherein the core, which is a lithium-based active material, is a layered-structured oxide having a nickel content of 60 mol % or greater.

5. The composite cathode active material of claim 1, having a specific surface area in the range of 2 m²/g to 5 m²/g based on BET.

6. The composite cathode active material of claim 1, wherein the carbon layer is manufactured by using a pickering emulsion process.

7. A method for manufacturing the composite cathode active material for a secondary battery according to claim 1, the method comprising:
mixing carbon nanotubes and a cellulose-based organic matter with a first solvent to prepare a first solution;
irradiating the first solution with ultrasonic waves to disperse the carbon nanotubes and the cellulose-based organic matter;
introducing a second solvent to the dispersion-treated first solution, the second solvent not being miscible with the first solvent and having a different boiling point therefrom, and mixing the second solvent therewith, to prepare a second solution in a pickering emulsion state;
introducing a cathode active material to, and mixing the same with the second solution to prepare a first slurry;
removing an internal solvent of droplets forming the pickering emulsion from the first slurry to prepare a second slurry;
separating a solid-phase material and a liquid-phase material from the second slurry; and
heat-treating the separated solid-phase material.

8. The method of claim 7, wherein the cellulose-based organic matter is selected from the group consisting of ethyl cellulose, cellulose acetate, carboxymethyl cellulose, hydroxypropyl cellulose, methyl cellulose, nitrocellulose, and a combination thereof.

9. The method of claim 7, wherein the first solvent or the second solvent is selected from the group consisting of polar substances such as water, methanol, ethanol, acetic acid, acetone, dimethyl sulfoxide, acetonitrile, and a combination thereof, and non-polar substances such as heptane, hexane, benzene, toluene, chloroform, and a combination thereof.

10. The method of claim 7, wherein the weight ratio of the cellulose-based organic matter to the carbon nanotubes is in the range of 1 to 5.

11. The method of claim 7, wherein the preparation of the pickering emulsion comprises introducing the second solvent to the first solution and irradiating ultrasonic waves.

12. The method of claim 7, wherein the heat-treatment is performed in the range of 150° C. to 800° C., and carbonizes the cellulose-based organic matter.

13. A dry electrode for a secondary battery, comprising the composite cathode active material for a secondary battery according to claim 1.

14. A secondary battery comprising the dry electrode for a secondary battery according to claim 13.
